(19) United States
(12) Patent Application Publication
(10) Pub. No.: US 2012/0192655 A1
(43) Pub. Date: Aug. 2, 2012

(54) DEVICE FOR PERFORMING COMPONENT AND MATERIAL TESTS ON SAMPLES

(76) Inventor: Ulrich Kindermann, Erbach (DE)

(21) Appl. No.: 13/387,145

(22) PCT Filed: Jun. 17, 2010
(86) PCT No.: PCT/DE2010/000681

§ 371 Date: Feb. 8, 2012

(30) Foreign Application Priority Data
Aug. 5, 2009 (DE) 10 2009 036 247.9

(51) Int. Cl. G01N 3/08

(52) U.S. Cl. 73/818

(57) ABSTRACT

The device is used to perform component and material tests on samples, in particular compression tests and tensile tests on springs and elastic components, assemblies, and material samples. The device comprises two sample retainers (2.1, 2.2) arranged opposite each other, between which sample retainers a force for loading the sample (1) arranged therebetween can be generated, wherein one sample retainer (2.1) is fixed to a base frame (3) and the other sample retainer (2.2) is arranged on a movable adjusting element (4). Furthermore, the device is provided with a displacement recorder (6) that detects the travel of the sample retainer (2.2) by means of a displacement sensor (5) and a force transducer (7) that detects the force applied to the sample (1). The adjusting element (4) comprises a hollow-drilled spindle (8), which surrounds the displacement sensor (5) at a small distance and which is connected to the sample retainer (2.2), and a gear rack, of a hydraulic or pneumatic cylinder or the like, by means of the manual or motorized force application occurs coaxially or at least nearly coaxially to the testing axis (9).

The invention relates to an apparatus for conducting component and material tests on samples, in particular, compression and tensile tests on springs and elastic components, assemblies, and material samples, comprising two spaced sample holders between which a force can be generated so as to apply a load to the sample therebetween, the one sample holder being fixed to a base frame while the other sample holder is carried on a movable positioner, furthermore comprising a motion detector that uses a probe to record the travel distance of the sample holder, and comprising a force sensor that records the force applied to the sample.

Various embodiments of these types of apparatuses are well-known from practice in which, however, first-order measurement errors according to Abbe are observed depending on the constructive design whenever the path to be measured and the measurement standard are not aligned.

In addition, tilt errors and elastic deformations occur due to the fact that the application of force is typically effected outside the test axis, with the result that measurement precision is also degraded.

The object of this invention is to improve an apparatus of the above-described type so as to largely minimize the measurement errors due to tilt motions caused by the application of force outside the test axis, and additionally to design the apparatus so as to enable a continuous force-displacement graph to be recorded instead of recording individual measurement points.

This object is achieved according to the invention by an approach wherein the positioner includes a tubular force application element that surrounds the probe with a small clearance and is connected to the sample holder, the force application element being in the form of a spindle, gear rack, hydraulic unit, or pneumatic cylinder, or the like, through which the manual or motorized application of force is effected coaxially or at least nearly coaxially relative to the test axis.

The advantage achieved by the invention consists essentially in the fact that tilting moments by forces that engage the positioner eccentrically and act to deform the sample are largely prevented, with the result that measurement errors also caused thereby are considerably minimized.

To this end, a preferred embodiment of the invention is provides an additional design aspect whereby in the case of the force application element in the form of a spindle this spindle is attached by a spindle nut to the positioner.

In addition, it is recommended within the scope of the invention that the positioner be connected through a backlash-free guide on the base frame. This allows any lateral forces occurring to be absorbed by this additional guide.

In order to implement the application of force in a force application element in the form of gear rack, the invention proposes that the gear rack be provided with a radially extending row of teeth to which the application of force is effected by a pinion.

It is recommended here that the positioner be provided with a cut-out in the region of the rack through which engages the pinion.

In a first embodiment of the invention, the rack is formed in the cylindrical peripheral surface of the gear rack. The pinion here can have an outer shape that is matched to the peripheral surface of the gear rack.

In a second, metrologically even more advantageous embodiment of the invention, the gear rack is provided with an axially extending cut-out at least in the region of the rack, by which a U-section is created that half surrounds the probe, wherein both edges are provided with a rack, and one pinion each on a common shaft engages each rack. As a result, the application of force is effected uniformly on both sides of the actual measurement axis, where, given an appropriate design of the spindle, the actual application of force can be effected directly in the plane of the measurement axis. This embodiment thus does not produce any tilt errors, or at worst only the most minimal tilt errors.

The following discussion describes the invention in more detail based on the embodiments illustrated in the drawing; therein:

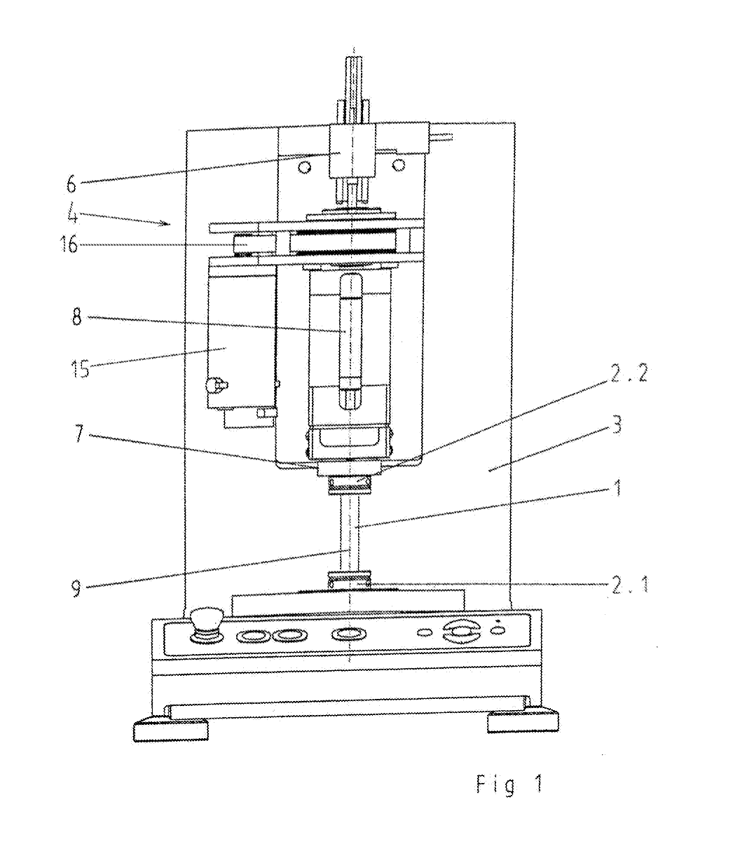

FIG. 1 is a front view of the apparatus of the invention;

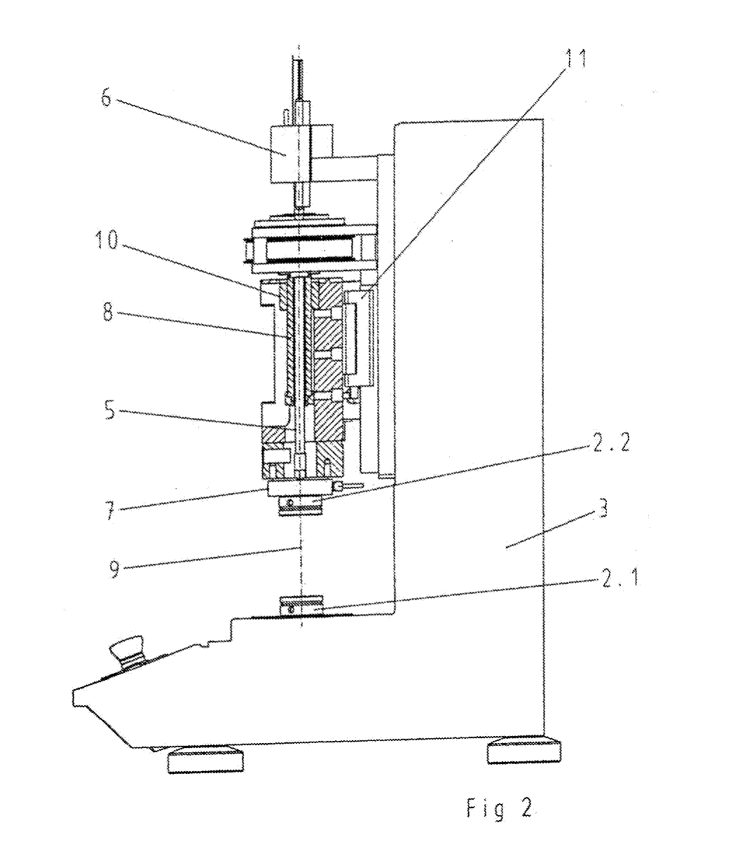

FIG. 2 is a partial side view of the apparatus illustrated in FIG. 1;

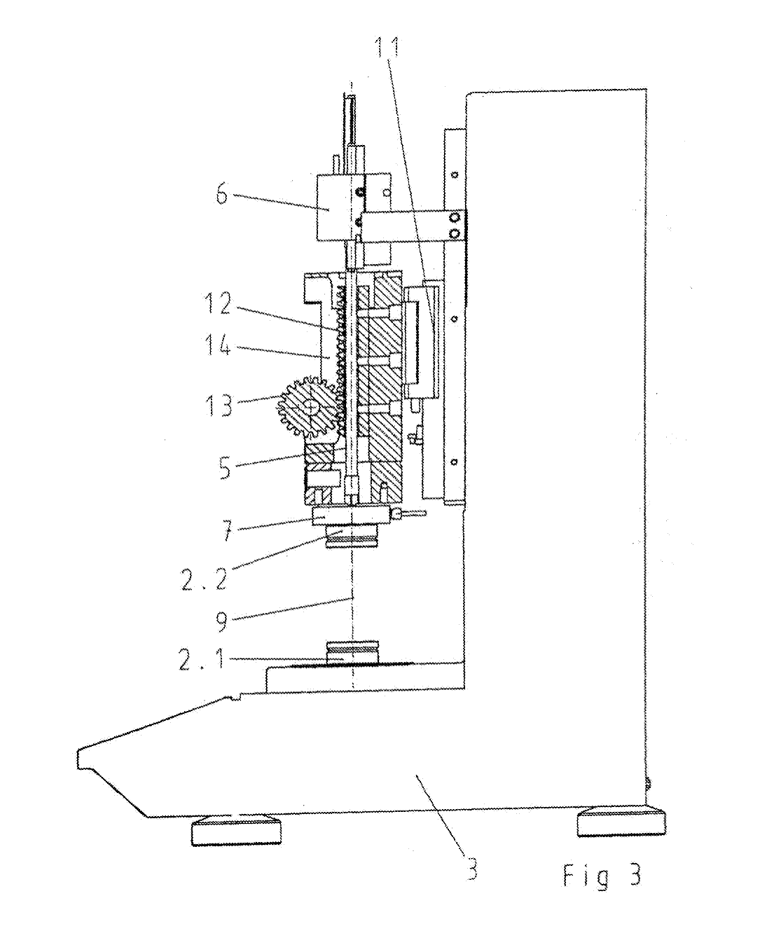

FIG. 3 is a similar view of an alternative embodiment of the apparatus of the invention of FIG. 2;

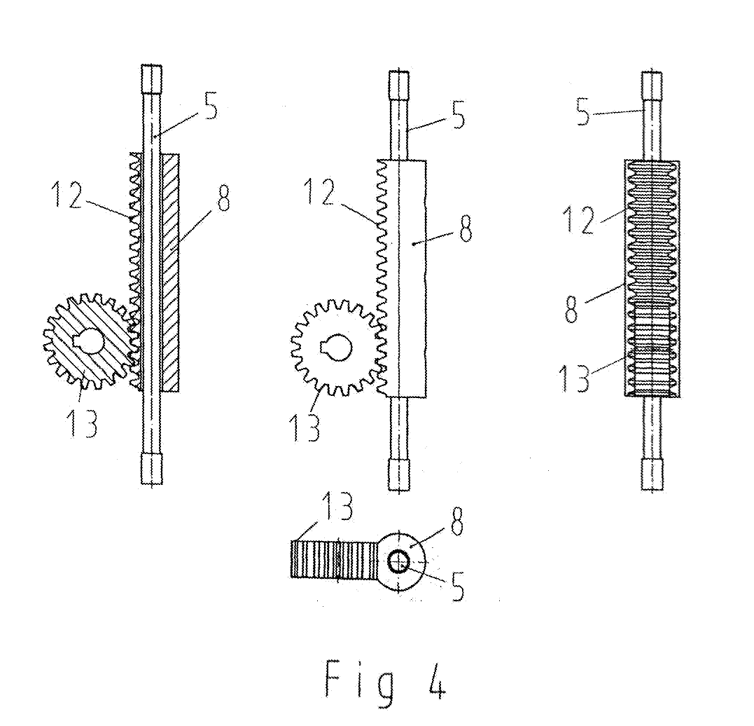

FIG. 4 is side, top, end, and sectional views of a first embodiment of the gear rack of the apparatus in FIGS. 1 and 2;

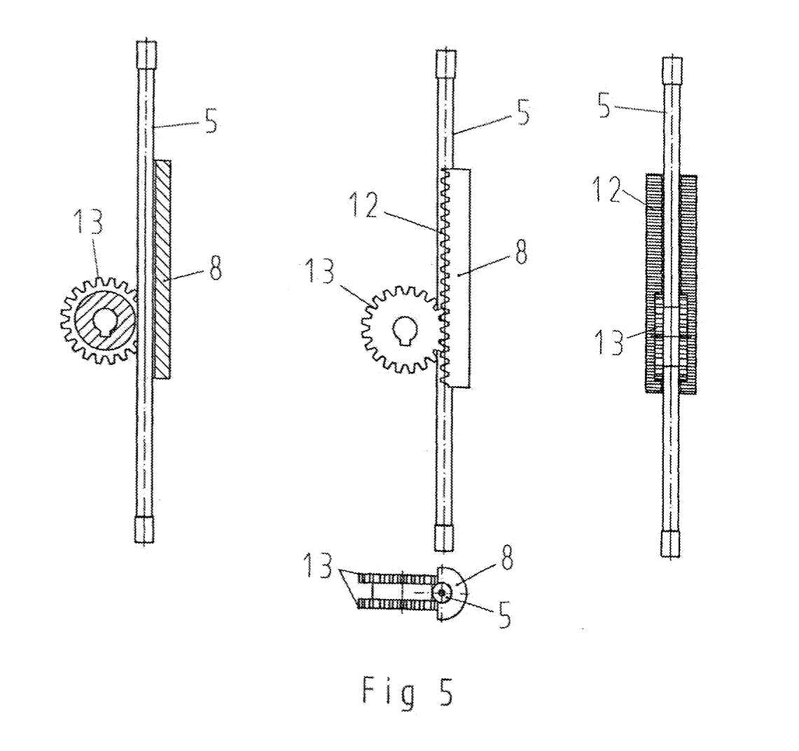

FIG. 5 shows an alternative embodiment of the gear rack, illustrated as in FIG. 4.

The apparatus showed in the drawing functions to conduct component tests and material tests on samples 1, in particular, compression and tensile tests of springs and elastic components, assemblies, and material samples.

Specifically, the apparatus has two spaced sample holders 2.1 and 2.2 between which a force can be generated so as to apply a load to the sample 1 between these sample holders 2.1 and 2.2.

The lower sample holder 2.1, is fixed to a base frame 3, while the upper sample holder 2.2 is on a movable positioner 4.

A probe 5 is connected to a motion detector 6 so the is travel distance of upper sample holder 2.2 can be determined.

In addition, the upper sample holder 2.2 is connected to a force sensor 7 that records the force applied to the sample 1.

In the embodiment of FIGS. 1 and 2, the positioner 4 includes a tubular spindle 8 that is connected to the sample holder 2.2 and that surrounds the probe 5 with a small clearance. The manual or motorized application of force is effected through this spindle 8 and takes place coaxially relative to a measurement axis 9 due to the small clearance.

The spindle 8 itself is attached as shown in FIG. 2 by a spindle nut 10 to the positioner 4, and is rotated by a motor 15 through a transmission 16. In addition, the positioner 4 is connected through a backlash-free guide 11 to the base frame 3, as is also evident in FIG. 2.

As FIGS. 3 through 5 illustrate, a gear rack 12 with an axial row of teeth can also be employed in place of the spindle 8. A pinion 13 is meshed with this rack 12 and can axially shift the gear rack 8. This can be effected either by hand as indicated in the drawing or by an electric motor. Although the application of force here is effected slightly eccentrically, this nevertheless still is applied substantially coaxially.

As is evident in FIG. 3, the positioner 4 is provided with a cut-out 14 in the region of the rack to accommodate the pinion 13.

As showed in FIG. 4, the rack 12 can be formed in the cylindrical peripheral surface of the spindle 8, and the pinion 13 can for this purpose have a shape designed to match the teeth of the gear rack 8.

In contrast to this, the spindle 8 in the embodiment of FIG. 5 is provided with an axially extending cutout at least in the region of rack 12, as the result of which gear rack 8 is a semicylinder that half surrounds the probe 5. Both edges of the U-section gear rack 8 are provided with respective racks 12 that flank the plane of the test axis such that, although the application of force is effected on both sides of the test axis, it is nevertheless effected directly in the plane of this axis.

Two respective pinions on a common shaft engage the two racks, thereby causing the resulting force to fall in the test axis. Similarly, it is also possible instead to employ a single pinion having a radial recess.

1. An apparatus for conducting component and material tests on samples, in particular compression and tensile tests on springs and elastic components, assemblies, and material samples, comprising two spaced sample holders between which a force can be generated so as to apply a load to the sample therebetween, wherein the one sample holder is fixed to a base frame, while the other sample holder is on a movable positioner, furthermore comprising a motion detector that uses a probe to record the travel distance of the sample holder, and comprising a force sensor that records the force applied to the sample, wherein the positioner includes a tubular force application element that surrounds the probe with a small clearance and is connected to the sample holder, the force application element being in the form of a spindle, gear rack, hydraulic unit, or pneumatic cylinder, or the like, through which the manual or motorized application of force is effected coaxially or at least nearly coaxially relative to the test axis.

2. The apparatus according to claim 1, wherein in the case of a force application element in the form of a spindle this spindle is attached by a spindle nut to the positioner.

3. The apparatus according to claim 1, wherein the positioner is connected to the base frame through a backlash-free guide

4. The apparatus according to claim 1, wherein the application of force is effected by a pinion when the force application element is a spindle having an axially extending rack.

5. The apparatus according to claim 4, wherein the positioner is formed with a cut-out in the region of the rack through the pinion engages.

6. The apparatus according to claims 4 wherein the rack is formed in the cylindrical outer surface of the spindle.

7. The apparatus according to claims 4 wherein the spindle is provided with an axially extending cut-out at least in the region of the rack, thereby creating a tubular semicylinder that only half surrounds the probe, wherein both edges are provided with a rack, and one pinion each on a common shaft engages each rack.

8. An apparatus for testing a sample, the apparatus comprising:
a base frame;
a fixed holder fixed to the base frame and adapted to hold one side of a sample;
a tubular force application element centered on and shiftable on the frame along an axis passing through the fixed holder;
a movable holder carried on the force-application element and adapted to hold another side of the sample held in the fixed holder;
positioning means between the force application element and the base frame for displacing the force application element axially toward or away from the fixed holder for applying compressive or tensile forces to the sample held in the holders;
a probe extending spacedly along the axis through the force application element and bearing axially through the movable holder with the sample; and
motion-detecting means between the probe and the base frame for measuring displacement of the probe and deformation of the sample, whereby material characteristics can be determined from the force applied by the element to the sample and the displacement of the probe.

9. The test apparatus defined in claim 8, wherein the force application element has an axially extending rack and the positioning means includes a pinion meshing with the rack.
